(19) United States
(12) Patent Application Publication
(10) Pub. No.: US 2006/0197347 A1
(43) Pub. Date: Sep. 7, 2006

(54) Front bumper with swinging ends

(76) Inventors: Lawrence Hoffman, Hoagland, IN (US); Katrina R. Hunden, Fort Wayne, IN (US); Peter J. Voors, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/073,298

(22) Filed: Mar. 3, 2005

(51) Int. Cl. B60R 19/02

(52) U.S. Cl. 293/102

(57) ABSTRACT

A front bumper for a mobile vehicle having separate swinging end assemblies to provide additional access to the vehicle engine. The front bumper and separate swinging end assemblies are provided in various embodiments, exemplifying possible modes of configuration and operation thereof. Specifically, methods of retaining the separate swinging end assemblies in a non-articulated position are presented, as well as the operative and styling advantages of the invention.

### BACKGROUND OF INVENTION

This invention relates to a front bumper with swinging ends that provides easy access to the engine compartment of a mobile commercial vehicle. Specifically, multiple embodiments are disclosed, by means of which the ends of the vehicle front bumper, which ordinarily prevent access to the engine compartment, may be rotated forward. In this way, the rearwardly swept ends of the front bumper are moved out of the way.

### SUMMARY

Mobile vehicles, especially heavy and medium-duty commercial vehicles, are commonly configured with the engine located longitudinally forward of the cab and mounted to a set of frame rails, which form the structure of the vehicle. Due to the overall size of these commercial vehicles, access to the engine and associated mechanical systems is provided by means of a forward tilting hood. This is in contrast to a passenger vehicle hood that lifts up from the front and provides access from the top of the engine compartment. This tilting hood allows a technician to service the vehicle engine from a standing position.

Additionally, these heavy and medium-duty commercial vehicles are provided with a front bumper, located forward and below the tilting hood. For reasons of aerodynamics, aesthetics, and safety, this front bumper commonly has ends that wrap around the front corners of the vehicle, so that they extend rearwardly before terminating. A front bumper with the characteristic of rearwardly extending termini is known as a “wrap-around” or “swept” front bumper. Occasionally, the front bumper is integrated into the forward tilting hood, but more often it is fixedly mounted to the vehicle frame rails.

In the case of previous fixedly attached wrap-around front bumpers, the rearwardly extending termini of the front bumper presented a barrier to a technician attempting to access the engine compartment. This forced the technician to climb over the end of the front bumper, or to squeeze between it and the vehicle front tire. The proximity of the rearwardly extending terminus of the front bumper to the vehicle front tire also prevented rapid egress from a standing position between the vehicle front tire and the engine compartment, a position often occupied by a technician when servicing the vehicle engine. It sometimes even presented a barrier to a technician attempting to access the underside of the engine compartment using a mechanic's creeper.

In the case of previous wrap-around front bumpers that were integrated into the vehicle hood, a major drawback of the integrated design was the fact that, in the event of damage to the front bumper, either the entire vehicle hood would require replacement, or significant work would be involved in detaching the front bumper from the hood assembly.

The invention disclosed herein provides a wrap-around front bumper with rearwardly extending termini having the capability of being independently swung forward and out of the path of access to the vehicle engine. These rearwardly extending termini are separately formed from the center portion of the front bumper, and are mounted to structural braces, which in turn pivot about points affixed to the vehicle frame rails. The rearwardly extending termini themselves are allowed to pivot on the ends of the structural braces distal from the chassis, so that the rearwardly extending termini and the center portion of the front bumper clear one another upon articulation. Additionally, as the figures will illustrate, another advantage of allowing the rearwardly extending termini to pivot on the ends of the structural braces distal from the chassis, is that the joint lines between the rearwardly extending termini and the front bumper center section may be configured to match the aesthetics of the vehicle, rather than being constrained to the intercept of the front bumper surface and a cylinder projected about a given single pivot line. The structural braces are of sufficient strength that the impact and load bearing characteristics of the rearwardly extending termini are retained. Various ways of releasably affixing the swinging assemblies to the center portion of the front bumper are disclosed.

The figures listed illustrate a vehicle with a front bumper which is divided into three sections per the invention disclosed, that is, having a center section and separate swinging ends. The structural braces and pivot mechanisms are shown, as well as various methods of releasably fixing the swinging assemblies, as mentioned previously.

The invention as presented is a solution to one of the maintenance difficulties heretofore inherent in the design of heavy-duty commercial vehicles with wrap-around front bumpers. It allows access to the vehicle engine without requiring a technician to climb over the rearwardly extending termini of the front bumper, while retaining the aerodynamic, aesthetic, and safety advantages of the wrap-around front bumper design. Additionally, it allows the use of a non-integrated front bumper, so that in the event of damage to the front bumper center section or swinging ends, removal and replacement of the damaged component remains a simple procedure.

### DRAWINGS

FIG. 1—A front view of a vehicle upon which the invention may be used.

FIG. 2—A side view of a vehicle upon which the invention may be used.

FIG. 3—A side view of a vehicle upon which the invention may be used.

FIG. 4—A rear view of a vehicle made in accordance with a first embodiment of the invention.

FIG. 5—A rear view of a vehicle made in accordance with a second embodiment of the invention.

FIG. 6—A front view of a vehicle made in accordance with a third embodiment of the invention.

FIG. 7—A detailed view of a left front bumper swinging end assembly affixed to a front bumper in accordance with a fourth embodiment of the invention.

FIG. 8—A detailed view of a left front bumper swinging end assembly affixed to a front bumper in accordance with a fifth embodiment of the invention.

### DETAILED DESCRIPTION

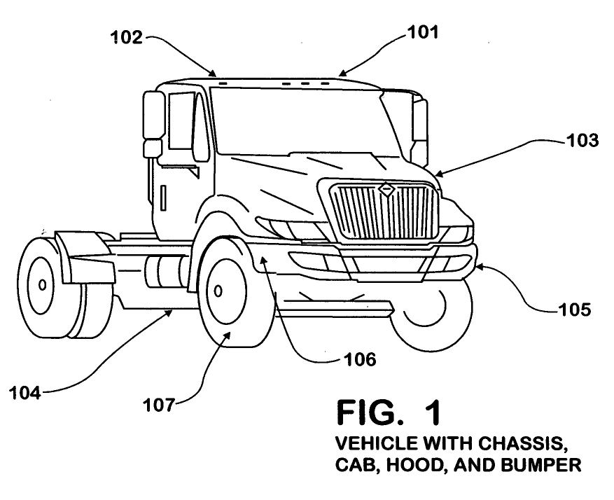

The vehicle 101 shown in FIG. 1 has a cab 102 and a hood 103 engaged to a chassis 104. The vehicle 101 also has a front bumper 105 attached to the chassis 104. The chassis 104 is provided with front wheels 107. Furthermore, the front bumper 105 is provided with rearwardly swept termini 106, which are proximate to the front wheels 107. This is an example of the type of vehicle to which this invention may be applied.

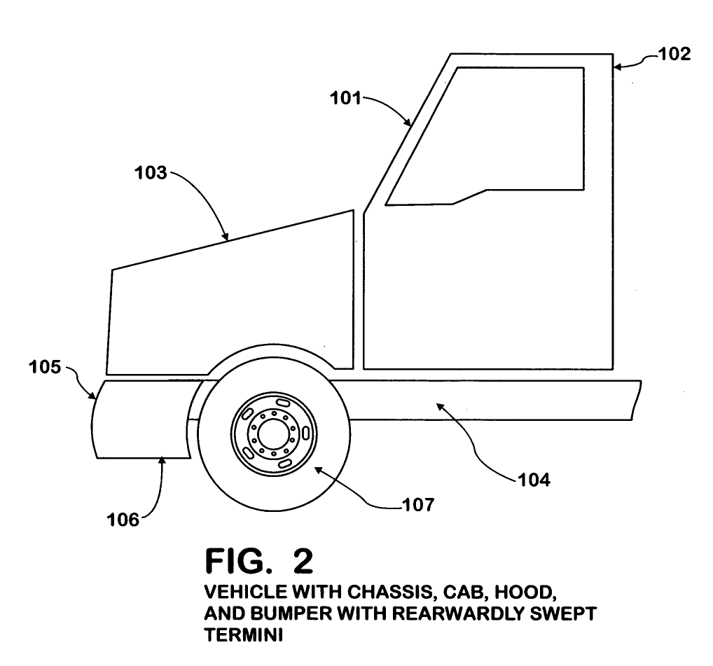

The vehicle 101 shown in FIG. 2 has a similar cab 102 and hood 103 attached to a chassis 104 as the vehicle 101 shown in FIG. 1. The front bumper 105 is also attached to the chassis 104, and is shown with a rearwardly swept terminus 106, proximate to the front wheel 107. This is another example of the type of vehicle to which this invention may be applied.

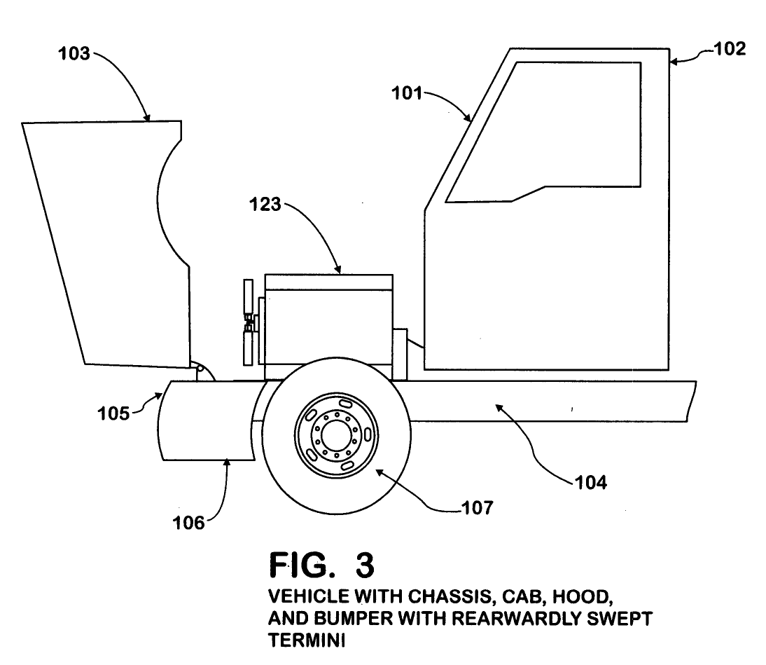

The vehicle 101 shown in FIG. 3 has a similar cab 102 and hood 103 attached to a chassis 104 as the vehicle 101 shown in FIG. 1. The front bumper 105 is also attached to the chassis 104, and is shown with a rearwardly swept terminus 106, proximate to the front wheel 107 as in FIG. 2. The hood 103 is shown in an open position, thereby providing access to an engine 123 installed on the chassis 104. Note that the rearwardly swept terminus 106 presents a barrier to the frontal area of the engine 123, which is an area commonly accessed for routine service.

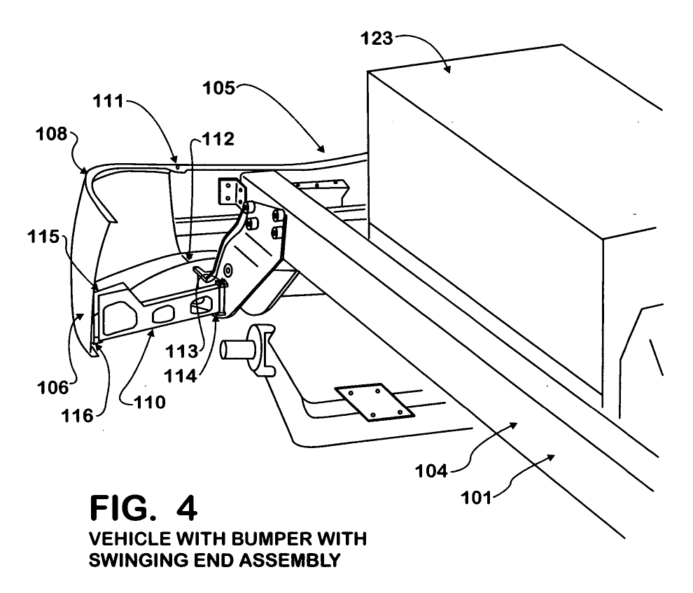

The vehicle 101 shown in FIG. 4 has a similar chassis 104 and an engine 123 as the vehicle 101 shown in FIG. 1. For the sake of clarity, the cab 102, the hood 103, and the front wheel 107 are not shown in FIG. 4. In accordance with the invention disclosed herein, the front bumper 105 is attached to the chassis 104, and is shown with the left front bumper swinging end assembly 108, of which the rearwardly swept terminus 106 is a part. The right front bumper swinging end assembly 109 is symmetrically opposite to the left front bumper swinging end assembly 108, and is not shown in FIG. 4. The left front bumper swinging end assembly 108 is comprised of the rearwardly swept terminus 106, which is pivotally attached to the structural brace 110, which in turn is pivotally attached to the chassis 104. The structural brace 110 pivots about the structural brace upper pivot point 113 and the structural brace lower pivot point 114. The rearwardly swept terminus 106 pivots about the rearwardly swept terminus upper pivot point 115 and the rearwardly swept terminus lower pivot point 116. Furthermore, the left front bumper swinging end assembly 108 is removably affixed to the front bumper 105 at the upper mounting point 111 and the lower mounting point 112, thereby preventing the left front bumper swinging end assembly 108 from articulating inadvertently. The pivotal attachment of the rearwardly swept terminus 106 to the structural brace 110 allows the rearwardly swept terminus 106 to clear the upper mounting point 111 and the lower mounting point 112 when it is detached and articulated. The right front bumper swinging end assembly 109 is similarly configured.

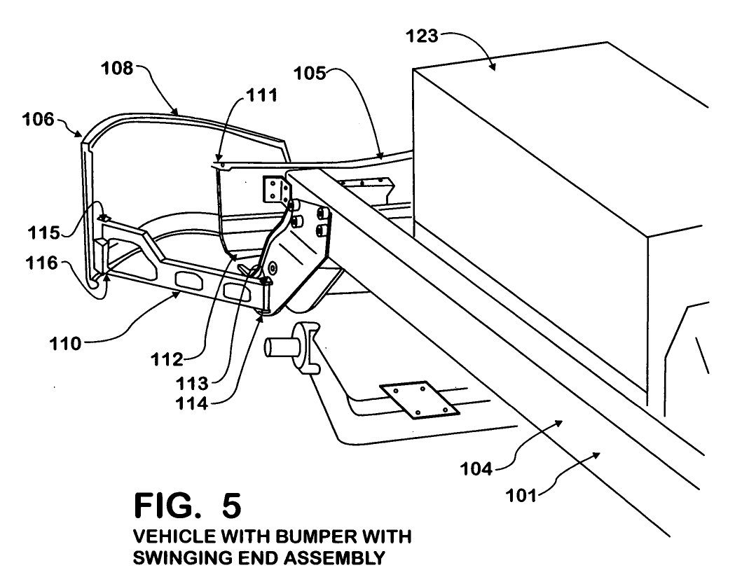

The vehicle 101 shown in FIG. 5 has a similar chassis 104, engine 123, front bumper 105, left front bumper swinging end assembly 108, rearwardly swept terminus 106, and structural brace 110, as the vehicle 101 shown in FIG. 4. For the sake of clarity, the cab 102, the hood 103, and the front wheel 107 are not shown in FIG. 5. Similar to the chassis 104 in FIG. 4, the right front bumper swinging end assembly 109 is not shown. Similar to the vehicle 101 shown in FIG. 4, the rearwardly swept terminus 106 is pivotally attached to the structural brace 110, which in turn is pivotally attached to the chassis 104. The structural brace 110 pivots about the structural brace upper and lower pivot points 113 and 114, respectively. The rearwardly swept terminus 106 pivots about the rearwardly swept terminus upper and lower pivot points 115 and 116, respectively. The left front bumper swinging end assembly 108 is shown detached from the upper mounting point 111 and the lower mounting point 112, and is shown articulated forward, thereby providing greater access to the engine 123.

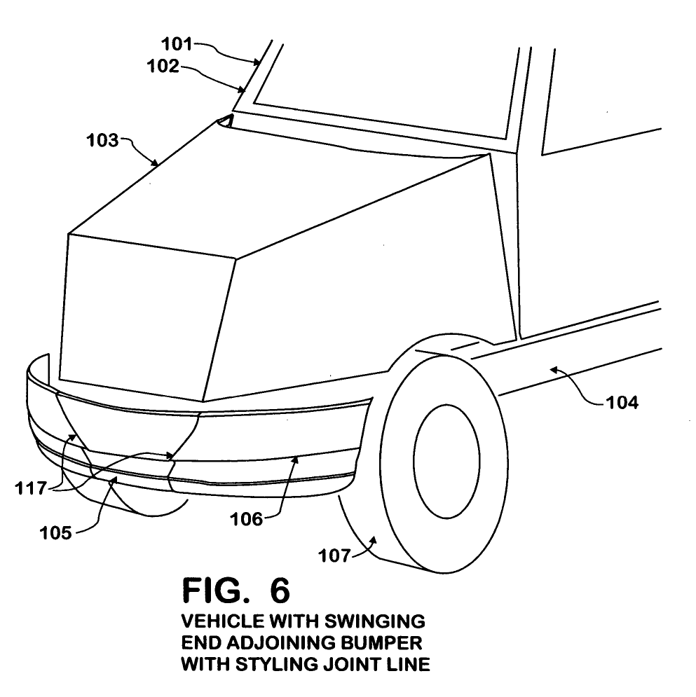

The vehicle 101 shown in FIG. 6 has a similar chassis 104, cab 102, hood 103, front wheel 107, front bumper 105, and rearwardly swept terminus 106 as the vehicle 101 shown in FIG. 1. The advantageous nature of having the structural brace 110 (not shown) pivot about the structural brace upper and lower pivot points, 113 and 114 respectively (not shown), and having the rearwardly swept terminus 106 pivot about the rearwardly swept terminus upper and lower pivot points, 115 and 116 respectively (not shown), is illustrated in the styling joint line 117. Specifically, the styling joint line 117 may be configured to match the aesthetics of the vehicle 101, rather than being constrained to the intercept of the front bumper surface and a cylinder projected about a given single pivot line, as noted previously.

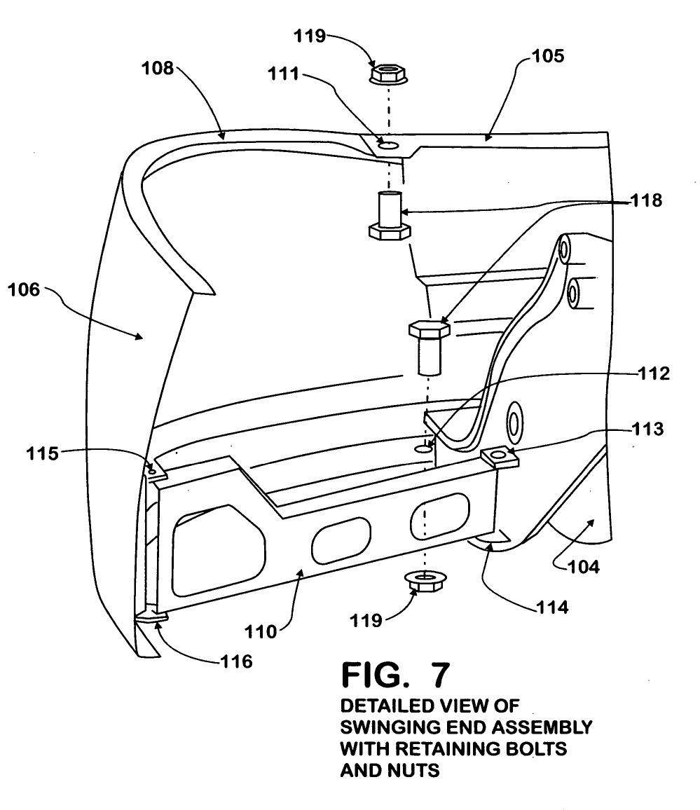

FIG. 7 is a detailed view of a left front bumper swinging end assembly 108, comprised of a rearwardly swept terminus 106 and a structural brace 110. For the sake of clarity, the cab 102, the hood 103, the front wheel 107, and the engine 123 are not shown. Similar to the left front bumper swinging end assembly 108 shown in FIG. 4, the rearwardly swept terminus 106 is pivotally attached to the structural brace 110, pivoting about the rearwardly swept terminus upper and lower pivot points 115 and 116 respectively. In the same way, the structural brace 110 pivots about the structural brace upper and lower pivot points 113 and 114 respectively, which are provided upon the chassis 104. Furthermore, as in FIG. 4, the left front bumper swinging end assembly 108 is removably affixed to the front bumper 105 at the upper mounting point 111 and the lower mounting point 112, thereby preventing the left front bumper swinging end assembly 108 from articulating inadvertently. Attachment of the left front bumper swinging end assembly 108 to the front bumper 105 is accomplished by the retaining bolt 118 and the retaining nut 119. The right front bumper swinging end assembly 109 (not shown) is similarly provided with retaining bolts and nuts.

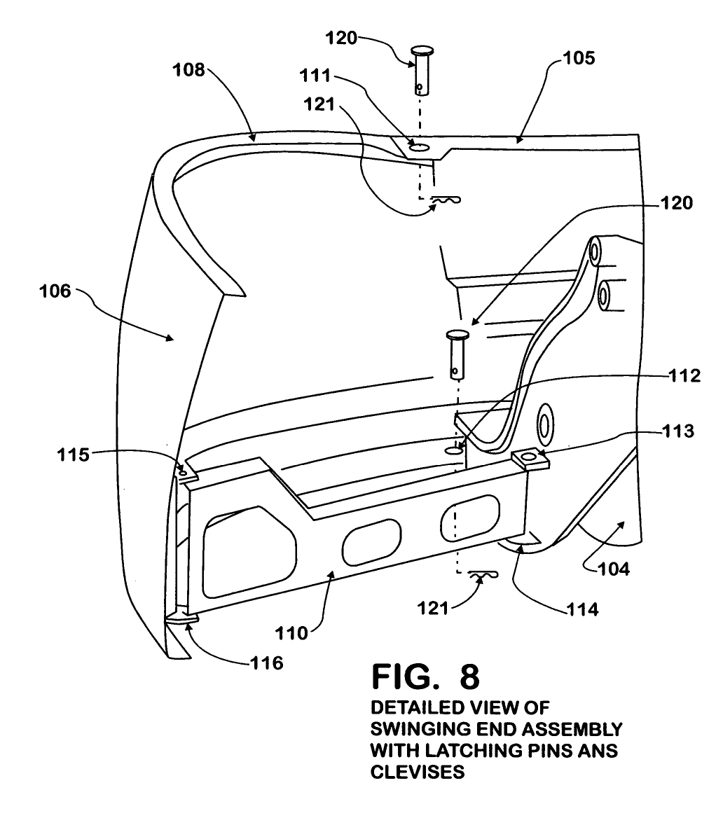

FIG. 8 is a detailed view of a left front bumper swinging end assembly 108, similar to the left front bumper swinging end assembly 108 that appears in FIG. 7. The left front bumper swinging end assembly 108 is again comprised of a rearwardly swept terminus 106 and a structural brace 110. For the sake of clarity, the cab 102, the hood 103, the front wheel 107, and the engine 123 are not shown. The rearwardly swept terminus 106 is again pivotally attached to the structural brace 110, pivoting about the rearwardly swept terminus upper and lower pivot points 115 and 116 respectively. In the same way, the structural brace 110 pivots about the structural brace upper and lower pivot points 113 and 114 respectively, which are provided upon the chassis 104. Furthermore, as in FIG. 7, the left front bumper swinging end assembly 108 is removably affixed to the front bumper 105 at the upper mounting point 111 and the lower mounting point 112, thereby preventing the left front bumper swinging end assembly 108 from articulating inadvertently. Attachment of the left front bumper swinging end assembly 108 to the front bumper 105 is accomplished by the latching pins 120 and the devises 121. The right front bumper swinging end assembly 109 (not shown) is similarly provided with latching pins and clevises.

Other permutations of the invention are possible without departing from the teachings disclosed herein, provided that the function of the right and left front bumper swinging end assemblies 108 and 109, respectively, is to allow greater access to the engine 123. Other advantages to a vehicle 101 equipped with right and left front bumper swinging end assemblies 108 and 109, respectively, may also be inherent in the invention, without having been described above.

We claim:

1. A mobile vehicle for operation on the ground, comprising:
a cab attached to a chassis;
an engine attached to said chassis and located forward of said cab relative to said mobile vehicle forward movement;
a hood hingedly attached to said chassis covering said engine, and providing access to said engine when in an open position; and
a front bumper attached to said chassis, said front bumper having a fixed center section and separate swinging end assemblies, said separate swinging end assemblies being capable of articulating forward.

2. The vehicle of claim 1, wherein:
said separate swinging end assemblies are further comprised of rearwardly extending termini, said rearwardly extending termini being pivotally mounted to a structural brace, said structural brace being pivotally mounted to said chassis, and said rearwardly extending termini being detachably affixed to said fixed center section.

3. The vehicle of claim 2, wherein:
said separate swinging end assemblies being provided with detachable retaining devices, said detachable retaining devices attaching said rearwardly extending termini to said fixed center section, said detachable retaining devices preventing inadvertent articulation of said separate swinging end assemblies when attached, and allowing articulation of said separate swinging end assemblies when detached.

4. The vehicle of claim 3, wherein:
said detachable retaining devices further comprise conventional bolts and nuts;
said fixed center section being provided with holes for receiving said conventional bolts; and
said rearwardly extending termini being provided with holes for receiving said conventional bolts, said holes in said rearwardly extending termini being capable of alignment with said holes in said fixed center section, said conventional bolts being insertable through said holes, and said nuts being attachable to said bolts, thereby preventing inadvertent articulation of said separate swinging end assemblies.

5. The vehicle of claim 3, wherein:
said retaining devices further comprise pins and clevises;
said fixed center section being provided with holes for receiving said pins; and
said rearwardly extending termini being provided with holes for receiving said pins, said holes in said rearwardly extending termini being capable of alignment with said holes in said fixed center section, said pins being insertable through said holes, and said devises being attachable to said pins, thereby preventing inadvertent articulation of said separate swinging end assemblies.

6. A mobile vehicle for operation on the ground, comprising:
a cab attached to a chassis, said chassis being provided with front wheel and tire assemblies;
an engine attached to said chassis and located forward of said cab relative to said mobile vehicle forward movement;
a hood hingedly attached to said chassis covering said engine, and providing access to said engine when in an open position; and
a front bumper attached to said chassis, said front bumper having a fixed center section and separate swinging end assemblies, said separate swinging end assemblies being capable of articulating forward, said swinging end assemblies being proximate to said front wheel and tire assemblies when in a non-articulated position, and distant from said front wheel and tire assemblies when in an articulated position.

7. The vehicle of claim 6, wherein:
said separate swinging end assemblies are further comprised of rearwardly extending termini, said rearwardly extending termini being pivotally mounted to a structural brace, said structural brace being pivotally mounted to said chassis, and said rearwardly extending termini being detachably affixed to said fixed center section.

8. The vehicle of claim 7, wherein:
said separate swinging end assemblies being provided with detachable retaining devices, said detachable retaining devices attaching said rearwardly extending termini to said fixed center section, said detachable retaining devices preventing inadvertent articulation of said separate swinging end assemblies when attached, and allowing articulation of said separate swinging end assemblies when detached.

9. The vehicle of claim 8, wherein:
said detachable retaining devices further comprise conventional bolts and nuts;
said fixed center section being provided with holes for receiving said conventional bolts; and
said rearwardly extending termini being provided with holes for receiving said conventional bolts, said holes in said rearwardly extending termini being capable of alignment with said holes in said fixed center section, said conventional bolts being insertable through said holes, and said nuts being attachable to said bolts, thereby preventing inadvertent articulation of said separate swinging end assemblies.

10. The vehicle of claim 8, wherein:
said retaining devices further comprise pins and clevises;
said fixed center section being provided with holes for receiving said pins; and
said rearwardly extending termini being provided with holes for receiving said pins, said holes in said rearwardly extending termini being capable of alignment with said holes in said fixed center section, said pins being insertable through said holes, and said devises being attachable to said pins, thereby preventing inadvertent articulation of said separate swinging end assemblies.
